(19) United States
(12) Patent Application Publication
(10) Pub. No.: US 2009/0293851 A1
(43) Pub. Date: Dec. 3, 2009

(54) Method and apparatus for controlling an internal combustion engine

(76) Inventors: Thomas Bleile, Stuttgart (DE); Christina Stiller, Stuttgart (DE); Friedrun Heiber, Stuttgart (DE)

Correspondence Address: KENYON & KENYON LLP, ONE BROADWAY, NEW YORK, NY, 10004, US

(21) Appl. No.: 11/921,628

(22) PCT Filed: May 16, 2006
(86) PCT No.: PCT/EP2006/062340

§ 371 Date: May 26, 2009

(30) Foreign Application Priority Data
Jun. 9, 2005 (DE) 10 2005 026 503.0

(51) Int. Cl. F02M 25/07

(52) U.S. Cl. 123/568.26

(57) ABSTRACT

A method and apparatus for controlling an internal combustion engine having a first actuator for influencing the gas air mass flow delivered to the internal combustion engine, having a second actuator for influencing the high-pressure-side recirculated exhaust gas mass flow, and having at least one third actuator for influencing the low-pressure-side recirculated exhaust gas mass flow, a first actuating variable for the first actuator being predefinable based on a comparison between a first setpoint and a first actual value for the fresh air mass flow and/or on further modeled or measured variables, a second actuating variable for the second actuator being predefinable based on a comparison between a second setpoint and a second actual value for the high-pressure-side exhaust gas mass flow and/or on further modeled or measured variables, and at least one third actuating variable for the at least one third actuator being predefinable based on a comparison between a third setpoint and a third actual value for the low-pressure-side exhaust gas mass flow and/or on further modeled or measured variables.

### BACKGROUND INFORMATION

A method and an apparatus for controlling an internal combustion engine are described, for example, in German Patent Application No. DE 196 20 036. Therein a first actuator serves to influence the fresh air mass flow delivered to the internal combustion engine, and a second actuator serves to influence the recirculated exhaust gas mass flow. A regulating damper that is disposed in the intake duct downstream from the compressor is preferably used as the first actuator. A high-pressure-side exhaust gas recirculation valve that is disposed in the high-pressure-side exhaust gas recirculation duct preferably serves as the second actuator. To allow an accurate adjustment both of the fresh air mass flow and of the proportion of recirculated exhaust gas to be performed in certain operating states, both the exhaust gas recirculation valve and the regulating damper are operated in regulated fashion. A regulation of the intake manifold pressure, i.e. the pressure before entering the internal combustion engine, is usually performed. Regulation of the manifold pressure via the exhaust gas recirculation valve is based on the assumption that the exhaust manifold pressure always rises, regardless of the position of the regulating damper, when the high-pressure-side exhaust gas recirculation valve is opened further. This is correct, however, only when the regulating damper is advanced sufficiently far that a definite pressure drop occurs across the regulating damper. Beyond a certain regulating damper opening angle, however, this effect can reverse. In this case, when the exhaust gas recirculation valve is opened, more exhaust gas flows through the exhaust gas recirculation duct and therefore less mass flow flows through the turbine. The compressor therefore delivers less, and the pressure downstream from the compressor becomes lower. This in turn also causes the intake manifold pressure to drop. This ultimately means that the control direction of the intake manifold pressure control system, by way of the exhaust gas recirculation valve, can change as a function of the opening angle of the regulating damper. This behavior cannot be compensated for by the controller, and the setpoint therefore also cannot be established.

To eliminate these problems, previously unpublished German Patent Application No. DE 10 2004 035 316.6 proposes a method for controlling an internal combustion engine having a first actuator for influencing the fresh air mass flow delivered to the internal combustion engine, having a second actuator for influencing the recirculated exhaust gas mass flow, such that based on a comparison between a first setpoint and a first actual value for the fresh air mass flow, a first actuating variable for the first actuator is definable, and based on a comparison between a second setpoint and a second actual value for the exhaust gas mass flow, a second actuating variable for the second actuator is definable. Both the first actuating variable and the second actuating variable each have precontrol values superimposed on them, which values are definable via a model. With this method it is possible to prevent a reversal in control direction from occurring. The exhaust gas recirculation valve has the same control direction regardless of the position of the regulating damper. A substantial simplification in application is moreover achieved, since previously the exhaust gas recirculation rate had to be applied indirectly via the intake manifold pressure. With this method the exhaust gas recirculation rate can be predefined directly as a setpoint. With the precontrol system, which is based on a mapping of the controlled system, rapid establishment of the setpoints is achieved.

In addition to high-pressure-side exhaust gas recirculation, low-pressure-side exhaust gas recirculation is now desirable in certain fields of application. Here exhaust gas is taken off after a turbine and fed in before the compressor. A low-pressure exhaust gas recirculation duct is provided for this purpose. A low-pressure exhaust gas recirculation valve is then provided in order to allow the quantity of exhaust gas recirculated through the low-pressure duct to be influenced. In addition, further actuators such as, for example, an exhaust gas damper and/or a regulating damper before the infeed into the low-pressure-side exhaust gas recirculation system can be provided. In such a system, the problem then exists of simultaneously adjusting multiple setpoints, i.e. adapting them to desired actual values. For the setpoint for the high-pressure exhaust gas recirculation rate, the setpoint for the low-pressure exhaust gas recirculation rate, and the setpoint for the fresh air mass flow must be adjusted simultaneously.

Under certain physical boundary conditions, e.g. an actuator limit stop situation, it is necessary to set priorities among the individual setpoints, since the necessary degrees of freedom of the control system no longer all exist. For example, when the high-pressure-side exhaust gas recirculation valve has reached an open limit stop, it is no longer possible to establish all three setpoints simultaneously. With conventional control strategies this is possible either not at all or only with considerable application complexity, and problems result in particular in dynamic regions. Problems also exist in highly dynamic regions, since here the individual actuators can move in uncoordinated fashion. Control quality is thereby reduced, and in the worst case the setpoints cannot be established.

### SUMMARY OF THE INVENTION

To eliminate these problems, provision is made according to the present invention that the first actuating variable has a first model-based precontrol value superimposed on it, the second actuating variable has a second model-based precontrol value superimposed on it, and the third actuating variable has a third model-based precontrol value superimposed on it. The model-based precontrol values are determined by a model that maps a setpoint of the fresh air mass flow onto an actuating-variable setpoint of the first actuator and/or maps a setpoint of the high-pressure-side exhaust gas mass flow onto an actuating-variable setpoint for the second position and/or maps a setpoint of the low-pressure-side exhaust gas mass flow onto an actuating-variable setpoint for the third actuator. Each of these mappings represents, so to speak, an inversion of the particular controlled system.

The model makes possible a modeling at least of the mixed point volume V22 and of volume V21 before the actuator.

The actual values can be obtained with the aid of a second model with which the sensor signals that are present can be purged of interference effects, unmeasurable signals can be calculated, and further cost-intensive sensors can be avoided.

### BRIEF DESCRIPTION OF THE DRAWINGS

FIG. 1 schematically shows a block diagram of an internal combustion engine.

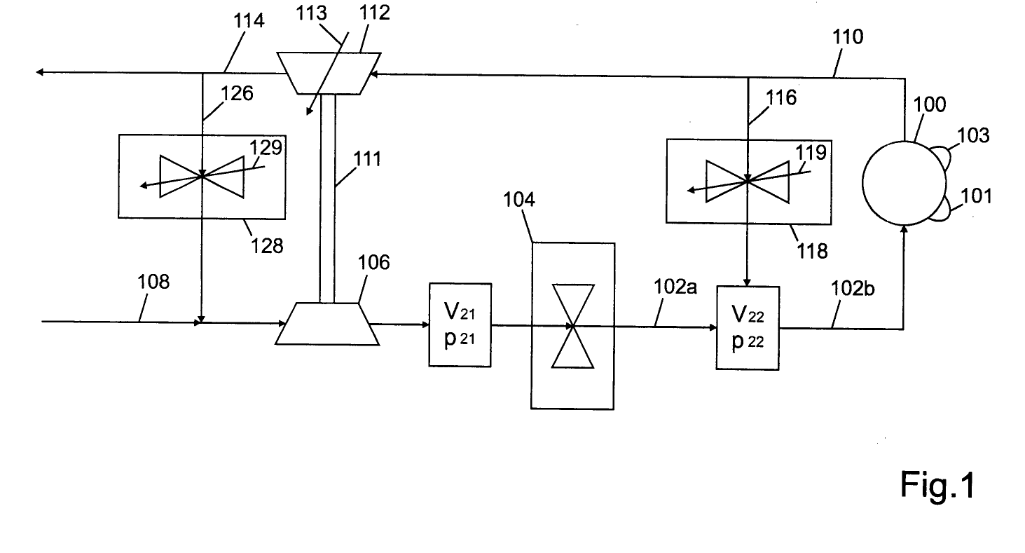

FIG. 2 is a block diagram of the procedure according to the present invention.

### DETAILED DESCRIPTION

The method according to the present invention will be described below using the example of a regulating damper, a high-pressure-side exhaust gas recirculation valve, and a low-pressure-side exhaust gas recirculation valve. The procedure according to the present invention is applicable in principle to all actuators with which a gas mass flow is influenced: for example, the fresh air mass flow, the high-pressure-side exhaust gas mass flow, and the low-pressure-side exhaust gas mass flow can be influenced. It is understood that instead of the fresh air mass flow or the high-pressure-side and low-pressure-side exhaust gas mass flow, other variables that correspond to these variables can also be controlled in closed- and/or open-loop fashion. What are described below as the actual values and setpoints of these variables are consequently variables that characterize the fresh air mass flow, the high-pressure-side recirculated exhaust gas mass flow, and the low-pressure-side recirculated exhaust gas mass flow. “Actuating variables” are understood to be suitable variables for triggering the corresponding actuators.

An internal combustion engine 100 has delivered to it, via a high-pressure fresh air duct 102, a specific gas quantity that contains a specific oxygen proportion. High-pressure fresh air duct 102 has two parts. A first part 102a extends to a location at which exhaust gas admixture is performed. A second part 102b extends to a location after which exhaust gas mixing has been performed. A regulating damper 104 is disposed in first part 102a.

Through a low-pressure fresh air duct 108, ambient air travels to a compressor 106 and then flows through regulating damper 104 into high-pressure fresh air duct 102. Through compressor 106, a quantity of air flows through regulating damper 104 into high-pressure fresh air duct 102. Located between compressor 106 and the regulating damper is volume V21 in which pressure P21 exists. At the mixed point, pressure P22 exists in volume V22.

From internal combustion engine 100, a quantity of air having a corresponding proportion of oxygen flows into a high-pressure exhaust gas duct 110. The high-pressure exhaust gas duct has a dividing point that leads on the one hand into a high-pressure-side exhaust gas recirculation valve 118, and on the other hand to a turbine 112. From turbine 112, the exhaust gas travels into a low-pressure exhaust gas duct 114 that is also referred to as an exhaust duct. Turbine 112 drives compressor 106 via a shaft 111. By way of a turbocharger actuator 113, the characteristics of turbine 112 and thus of the entire turbocharger can be influenced. For control application purposes, turbocharger actuator 113 is acted upon by a control application signal that results in a displacement of the turbocharger over a linear distance. The linear distance is also referred to as a turbocharger stroke, and the control application signal as a turbocharger actuating variable.

A connection that is referred to as a high-pressure-side exhaust gas recirculation duct 116 exists between high-pressure exhaust gas duct 110 and high-pressure fresh air duct 102. A quantity of exhaust gas flows through this high-pressure-side exhaust gas recirculation duct 116. The cross section of high-pressure-side exhaust gas recirculation duct 116 is preferably controllable by way of high-pressure-side exhaust gas recirculation valve 118. For control application purposes, an exhaust gas recirculation actuator 119 is acted upon by a control application signal that results in a displacement of exhaust gas recirculation valve 118 over a linear distance. The linear distance is also referred to as an exhaust gas recirculation valve stroke, and the control application signal as an exhaust gas recirculation valve actuating variable.

A connection that is referred to as low-pressure-side exhaust gas recirculation duct 126 also exists between low-pressure-side exhaust gas duct 114 and low-pressure-side fresh air duct 108. A quantity of gas flows through this low-pressure-side exhaust gas recirculation duct 126. The cross section of low-pressure-side exhaust gas recirculation duct 126 is preferably controllable by way of a low-pressure-side exhaust gas recirculation valve 128. For control application purposes, a low-pressure-side exhaust gas recirculation actuator 129 is acted upon by a control application signal that results in a displacement of exhaust gas recirculation valve 128 over a linear distance. The linear distance is also referred to as a low-pressure-side exhaust gas recirculation valve stroke, and the control application signal as a low-pressure-side exhaust gas recirculation valve actuating variable. The rotation speed at the crankshaft and/or camshaft of the internal combustion engine is furthermore sensed by way of a rotation speed sensor 101. Quantity adjusting elements 103 are additionally provided, which determine the quantity of fuel to be injected and delivered to the internal combustion engine. Adjusting elements 103 are acted upon by a quantity signal.

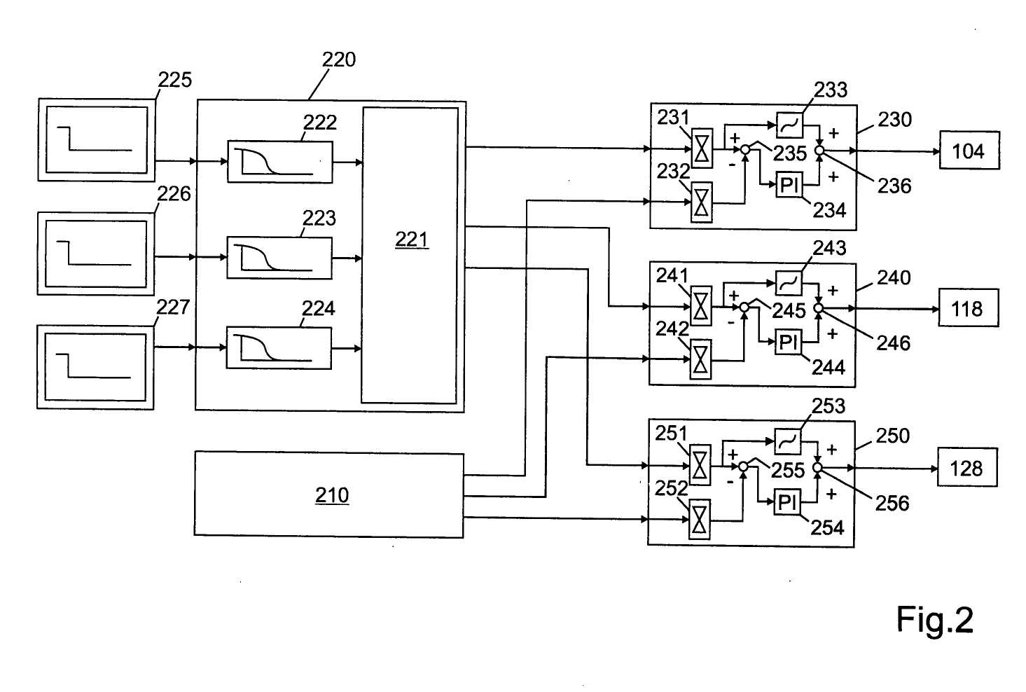

FIG. 2 schematically depicts the procedure according to the present invention with reference to a block diagram.

An actual-value ascertaining unit 210 respectively ascertains, on the basis of input variables (not depicted), an actual value for the fresh air mass flow, an actual value for the low-pressure-side recirculated exhaust gas mass flow, and an actual value for the high-pressure side recirculated exhaust gas mass flow. The actual-value ascertaining unit is preferably implemented by way of a model. A model calculation, for example for ascertaining the actual value of the fresh air mass flow, is described in German Patent Application No. DE 199 63 358, which is incorporated by reference in its entirety into the present Application for purposes of disclosure. The actual values for the low-pressure-side and high-pressure-side recirculated exhaust gas mass flows are also modeled in corresponding fashion. Actual-value ascertaining unit 210 can thus encompass multiple submodels. The output signals of the actual-value ascertaining unit travel respectively to controllers 230, 240, 250 to be explained below in further detail. Regulating damper 104, actuator 119 of high-pressure-side exhaust gas recirculation valve 118, and actuator 129 of low-pressure-side exhaust gas recirculation valve 129 are in turn acted upon by the output signals of controllers 230, 240, 250.

In a model labeled 220 in its entirety, setpoints of the respective actuators, i.e. of the regulating damper, of actuator 129 of low-pressure-side exhaust gas recirculation valve 128, and of actuator 119 of high-pressure-side exhaust gas recirculation valve 118, are calculated from input variables of fresh air mass flow 225, of low-pressure-side recirculated exhaust air mass flow 226, and of high-pressure-side recirculated exhaust gas mass flow 227. Model 220, which can also be referred to as an inverse model of the controlled system, encompasses for this purpose calculation devices 222, 223, 224 that perform actuating variable limitations, dynamic limitations, and other limitations and the like of input variables 225, 226, 227 governed by the system. If, for example, the fresh air mass flow exhibits a spike, this spike is “smoothed out” in calculation device 222. Corresponding actions occur with spikes in the low-pressure-side and high-pressure-side recirculated exhaust gas mass flows in the correspondingly depicted calculation devices 223 and 224. These, too, are dynamically adapted. In inverse model 221, which can be made up respectively of submodels of volume V22 and volume V21, setpoints for the gas mass flows at the actuators, i.e. the regulating damper, actuator 129 of low-pressure-side exhaust gas recirculation valve 128, and actuator 119 of high-pressure-side exhaust gas recirculation valve 118, can be determined and likewise delivered to calculation devices 230, 240, 250.

Each of these calculation devices 230, 240, 250 has the same configuration, so that the operation of these calculation devices 230, 240, 250 will be explained below by way of example with reference to calculation device 230 for determining regulating damper 104. Model 220, or the corresponding submodel, supplies mass flow setpoints to the respective controllers. These are converted via a further model, which maps the actuators as throttling elements, into effective flow-through cross sections, and then by way of the respective characteristic curves into an actuator stroke. This precontrol system has the advantage that changes in the setpoint can be reacted to very quickly, thus resulting in very fast command behavior. The system dynamics are already taken into account here. This means that by way of model 220 and the conversion into an actuator stroke, the high-pressure-side exhaust gas recirculation rate or the high-pressure-side recirculated exhaust gas mass flow, the low-pressure-side recirculated exhaust gas mass flow, or the low-pressure-side exhaust gas recirculation rate and the air mass flow can be adapted very quickly to changes in setpoint. This is advantageous in particular in the context of a switchover among different operating states, for example the switchover into or out of regeneration mode (e.g. for an NOx storage catalytic converter, particle filter regeneration, partially homogeneous operation).

Controller 230 encompasses two calculation units 231, 232. First calculation unit 231 is associated with the setpoint of the mass flow from precontrol system 220. Second calculation unit 232 is associated with the actual value of the fresh air mass flow, which is determined by model 210. These calculation units basically represent inverse throttling elements, since both regulating damper 104 and exhaust gas recirculation valves 118, 128 act respectively as throttling elements in the flow. The effective area of the throttling elements is obtained from the output signal of control device 231, i.e. from the set point (ascertained by precontrol system 220) for the mass flow and from the inverse throttling model. This area is then converted, with the aid of characteristic curve 233, into the precontrol signal of the regulating damper.

At the same time, after control device 232, the actual value of the effective area is subtracted from the output value of calculation device 231 at a node 235, and is delivered to a PI controller 234. PI controller 234 adapts the actual area to the area setpoint so that the setpoint of the air mass flow also corresponds to the actual air mass flow. For that purpose, the actual value made available by model 210 is compared with the filtered setpoint. Based on the deviation of the setpoint from the actual value, the actuating variable for application to regulating damper 104 is then defined by controller 234. The precontrol system constituted by model 220, calculation device 231, and characteristic curve 233 is superimposed on this control system. As already explained, the precontrol system model defines an actuating variable for regulating damper 104 based on the setpoint for the fresh air mass. Inverse model 221 of precontrol system 220 contains, for this purpose, a submodel that simulates a modeling of mixed point volume V22 and of volume V21 preceding the actuator (regulating damper 104).

1-10. (canceled)

11. A method for controlling an internal combustion engine having a first actuator for influencing a gas air mass flow delivered to the internal combustion engine, having a second actuator for influencing a high-pressure-side recirculated exhaust gas mass flow, and having at least one third actuator for influencing a low-pressure-side recirculated exhaust gas mass flow, the method comprising:
predefining a first actuating variable for the first actuator based on at least one of (a) a comparison between a first setpoint and a first actual value for a fresh air mass flow and (b) further modeled or measured variables;
predefining a second actuating variable for the second actuator based on at least one of (c) a comparison between a second setpoint and a second actual value for the high-pressure-side exhaust gas mass flow and (d) further modeled or measured variables; and
predefining at least one third actuating variable for the at least one third actuator based on at least one of (e) a comparison between a third setpoint and a third actual value for the low-pressure-side exhaust gas mass flow and (f) further modeled or measured variables.

12. The method according to claim 11, further comprising superimposing a first model-based precontrol value on the first actuating variable.

13. The method according to claim 11, further comprising superimposing a second model-based precontrol value on the second actuating variable.

14. The method according to claim 11, further comprising superimposing a third model-based precontrol value on the third actuating variable.

15. The method according to claim 11, further comprising providing a model that maps at least one of (a) a setpoint of the fresh air mass flow onto a setpoint of the first actuator, (b) a setpoint of the high-pressure-side exhaust gas mass flow onto a setpoint for the second actuator and (c) a setpoint of the low-pressure-side exhaust gas mass flow onto a setpoint for the third actuator.

16. The method according to claim 15, further comprising, by the model, performing a modeling at least of a mixed point volume and of a volume before the first actuator.

17. The method according to claim 11, further comprising predefining actual values by way of a further model.

18. The method according to claim 11, further comprising, by way of one controller in each case, at least one of:
adjusting the first actual value for the fresh air mass flow to the first setpoint for the fresh air mass flow;
adjusting the second actual value for the high-pressure-side recirculated exhaust gas mass flow to the second setpoint for the high-pressure-side recirculated exhaust gas mass flow; and
adjusting the third actual value for the low-pressure-side recirculated exhaust gas mass flow to the third setpoint for the low-pressure-side recirculated exhaust gas mass flow.

19. The method according to claim 18, wherein the controller includes a PI controller with model-based precontrol and area estimation.

20. An apparatus for controlling an internal combustion engine comprising:
a first actuator for influencing a gas air mass flow delivered to the internal combustion engine;
a second actuator for influencing a high-pressure-side recirculated exhaust gas mass flow;
at least one third actuator for influencing a low-pressure-side recirculated exhaust gas mass flow;
means for predefining a first actuating variable for the first actuator based on at least one of (a) a comparison between a first setpoint and a first actual value for a fresh air mass flow and (b) further modeled or measured variables;
means for predefining a second actuating variable for the second actuator based on at least one of (c) a comparison between a second setpoint and a second actual value for the high-pressure-side exhaust gas mass flow and (d) further modeled or measured variables; and
means for predefining at least one third actuating variable for the at least one third actuator based on at least one of (e) a comparison between a third setpoint and a third actual value for the low-pressure-side exhaust gas mass flow and (f) further modeled or measured variables.
